(19) United States
(12) Patent Application Publication
(10) Pub. No.: US 2026/0203444 A1
(43) Pub. Date: Jul. 16, 2026

(54) CONTROL METHOD, INFORMATION PROCESSING APPARATUS, AND STORAGE MEDIUM

(71) Applicant: CANON KABUSHIKI KAISHA, Tokyo (JP)

(72) Inventor: HIROYUKI UCHIDA, Chiba (JP)

(21) Appl. No.: 19/442,772

(22) Filed: Jan. 7, 2026

(30) Foreign Application Priority Data
Jan. 14, 2025 (JP) 2025-004918

(51) Int. Cl. G06F 21/62; G06F 3/0484

(52) U.S. Cl. CPC G06F 21/6254; G06F 3/0484

(57) ABSTRACT

A method includes receiving a predetermined operation performed to obtain consent to collection of individual-related information about a user, where the consent is limited to a specific session relating to management of display of a screen and deleting the individual-related information in a case where the predetermined operation is received.

### BACKGROUND

### Field of the Technology

The present disclosure relates to a control method, an information processing apparatus, and a storage medium.

### Description of the Related Art

To display information suitable for a user on a web page or to perform analysis of web access status, a manager of a web site may collect information, such as the user’s web page transition information and browsing time by using techniques, such as cookies. In recent years, regarding the collection of individual-related information, such as their web page transition information and browsing time, it has been necessary to obtain consent from the user. Thus, many web pages may display a screen (hereinafter, also referred to as an inquiry screen) including a warning message about the collection of individual-related information, and consent and reject buttons.

When the user presses the consent button or the reject button, the inquiry screen described above may be controlled to remain hidden until a predetermined period elapses. In such a case, the user may not be able to easily change their expression of consent to or rejection of the collection of individual-related information.

Japanese Patent Laid-Open No. 2016-143366 describes a technique in which information about a user’s expression of consent to or rejection of the collection of individual-related information and the individual-related information are stored in a cookie file, and the storage of such information is limited to a predetermined period to shorten the period until the inquiry screen is re-displayed.

There is a demand for enabling, in a more suitable form, reception of a user’s expression regarding the collection of individual-related information while the user is browsing a web page.

### SUMMARY

In view of the issue described above, the present disclosure is directed to a technique for enabling, in a more suitable form, reception of a user’s expression regarding the collection of individual-related information while the user is browsing a web page.

According to an aspect of the present disclosure, a method includes receiving a predetermined operation performed to obtain consent to collection of individual-related information about a user, where the consent is limited to a specific session relating to management of display of a screen, and deleting the individual-related information in a case where the predetermined operation is received.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of a configuration of an information processing system.

FIG. 2 is a sequence diagram illustrating an example of processing by the information processing system.

FIG. 3 is a diagram illustrating an example of a screen of a web page.

FIG. 4 is a flowchart illustrating an example of processing by an information processing apparatus.

FIG. 5 is a flowchart illustrating an example of processing by the information processing apparatus.

FIG. 6 is a flowchart illustrating an example of processing by the information processing apparatus.

FIG. 7 is a table illustrating an example of the relationship between flags and an expiration date, and a state of a browser.

### DESCRIPTION OF THE EMBODIMENTS

Some embodiments of the present disclosure will now be described in detail with reference to the accompanying drawings.

In the present specification and the drawings, components having substantially the same functional configuration are denoted by the same reference numerals, and redundant description will be omitted.

### First Embodiment

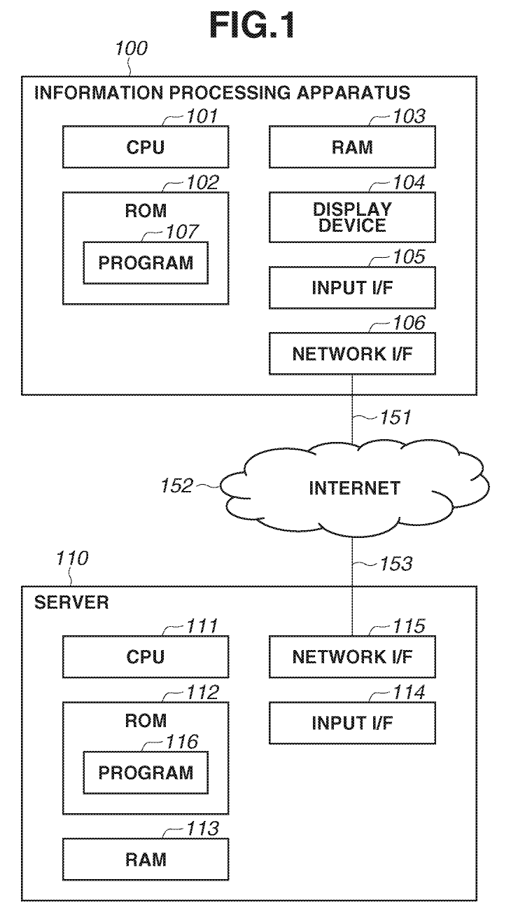

An example of the configuration of an information processing system according to a first embodiment of the present disclosure will be described with reference to FIG. 1. The information processing system according to the present embodiment includes an information processing apparatus 100 and a server 110.

The information processing apparatus 100 includes a central processing unit (CPU) 101, a read only memory (ROM) 102, and a random access memory (RAM) 103. The information processing apparatus 100 also includes a display device 104, an input interface (I/F) 105, and a network I/F 106.

The ROM 102 stores programs 107 including a web browser. The web browser is implemented by, for example, the CPU 101 reading the program code of the web browser from the ROM 102, loading the program code into the RAM 103, and executing the program code. Hereinafter, for convenience, processing may be described with the web browser as the subject. However, the processing is practically performed by the CPU 101 executing the program code of the web browser.

The web browser secures a nonvolatile storage area in the ROM 102 and a volatile storage area in the RAM 103. The web browser then stores an information collection accepted flag and optional information described in detail below in the nonvolatile storage area of the ROM 102. An expiration date can be set to each piece of information stored in the nonvolatile storage area of the ROM 102. The web browser may store the information collection accepted flag and an inquiry screen display flag described in detail below in the volatile storage area of the RAM 103. Each piece of the information (flags, optional information, and expiration date information) in each storage area has a null value as an initial value.

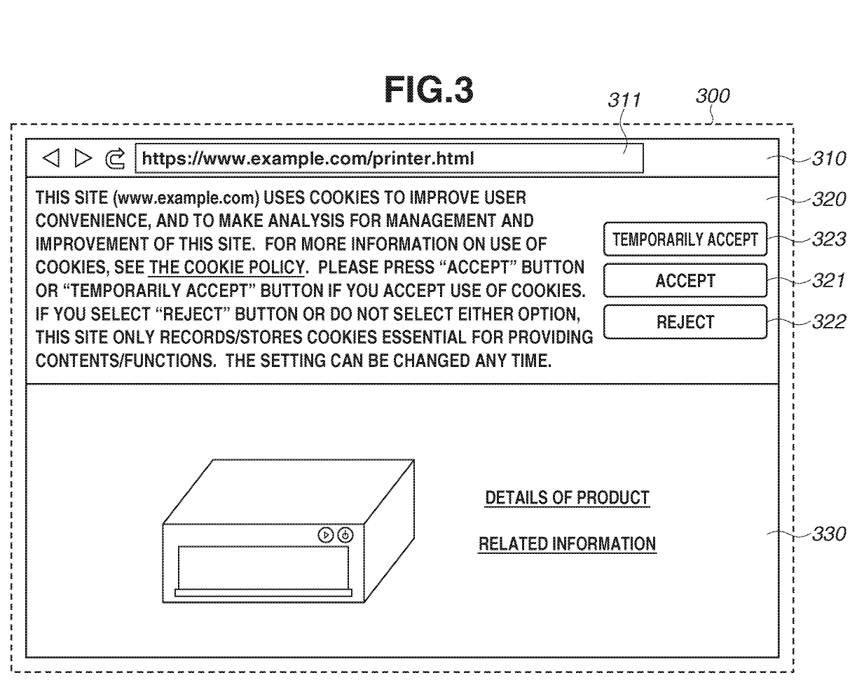

The above-described optional information according to the present embodiment refers to information representable using character strings, for example, web page transitions performed by the user through the web browser and web page browsing time. The optional information corresponds to an example of individual-related information according to the present embodiment. The information collection accepted flag is a value indicating whether the user permits the web browser to store the optional information in the nonvolatile storage area of the ROM 102 (information collection accepted flag is represented as ON or OFF. An ON state indicates permission and an OFF state indicates rejection). The inquiry screen display flag is a value indicating whether to cause the display device 104 to display an inquiry display portion (area) 320 described below with reference to FIG. 3 (the inquiry screen display flag is represented as ON or OFF. An ON state indicates display of the inquiry display portion and an OFF state indicates non-display of the inquiry display portion).

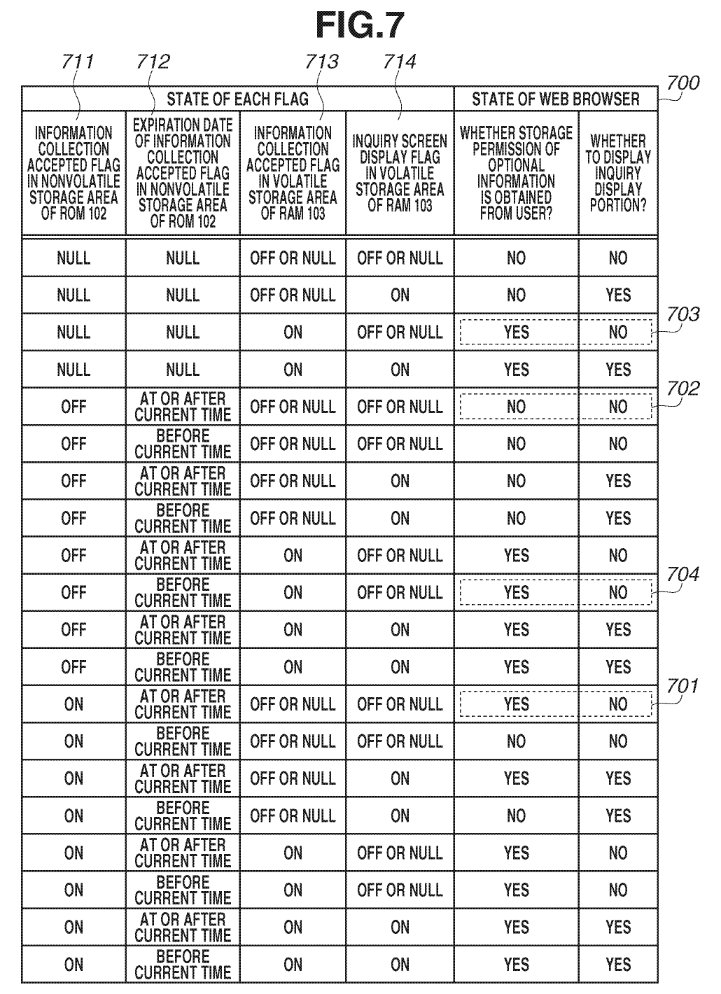

A state of the web browser corresponding to each combination of the flags and the expiration date information is as illustrated in a table 700 in FIG. 7.

The ROM 102 continuously stores the information stored in the nonvolatile storage area of the ROM 102 even after an operation of the web browser ends. After an operation of the web browser ends, the RAM 103 does not store (for example, discards) the information stored in the volatile storage area of the RAM 103.

The information processing apparatus 100 can be connected to the Internet 152 via network connection 151, such as wired connection using an Ethernet cable or wireless connection based on the standards of Wi-Fi^{®}. Similarly, the server 110 can be connected to the Internet 152 via network connection 153. This configuration enables the information processing apparatus 100 and the server 110 to communicate with each other via the Internet 152.

The server 110 includes a CPU 111, a ROM 112, a RAM 113, an input I/F 114, and a network I/F 115.

The ROM 112 stores programs 116, such as a web page and an information display control program. The information display control program according to the present embodiment may specifically correspond to a program of script, such as JavaScript, described in the web page. With respect to the information display control program, the web browser, which is implemented by executing a program loaded to the RAM 103 of the information processing apparatus 100, functions as an interpreter for executing the program of script.

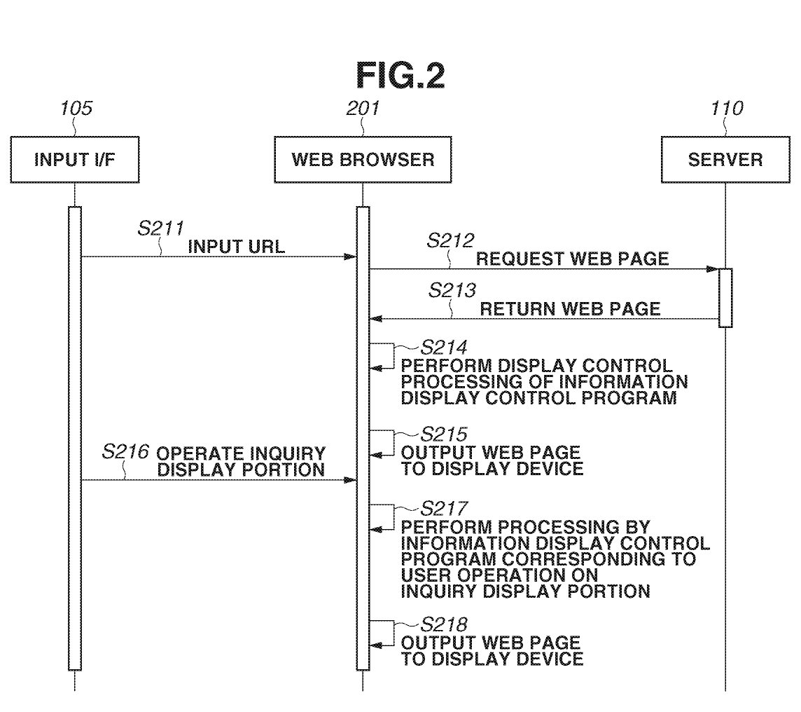

An example of a processing sequence by the information processing system according to the present embodiment will be described with reference to FIG. 2.

In step S211, the input I/F 105 of the information processing apparatus 100 receives input of a uniform resource locator (URL) corresponding to the web page including the information display control program from the user via a web browser 201 loaded to the RAM 103.

In step S212, the web browser 201 receives the input from the user in step S211, and requests a web page corresponding to the URL input by the user from the server 110 via the network I/F 106.

In step S213, in response to the request received in step S212, the server 110 returns the web page stored in the ROM 112 of the server 110 to the web browser 201 via the network I/F 115.

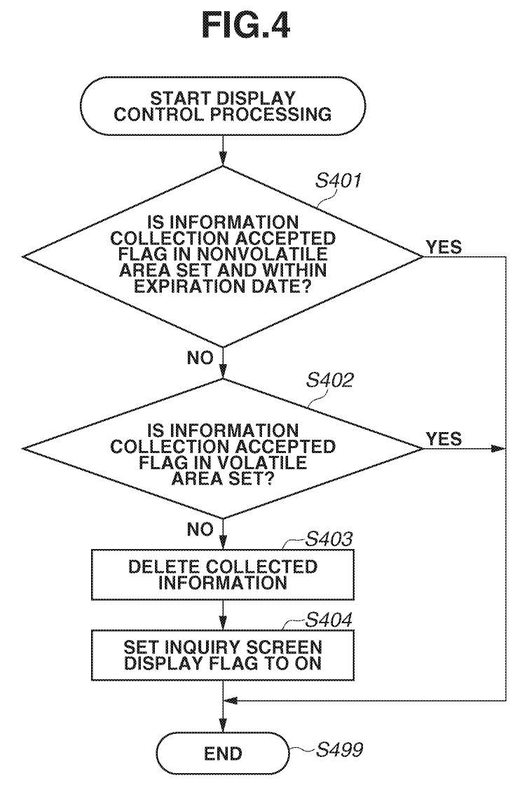

In step S214, the web browser 201 receives the response from the server 110 to perform display control processing of the information display control program included in the web page. Details of the processing in step S214 will be described below with reference to FIG. 4. In the information processing system according to the present embodiment, the web browser 201 may start a session at the time of displaying a web page, managing display of the web page in association with the session.

As a specific example, the web browser 201 may manage display of a web page by allocating a session to each window or each tab. In this case, the web browser 201 may individually manage various types of control relating to display of a web page for each session. For example, the web browser 201 may individually secure a storage area (a nonvolatile storage area or a volatile storage area) for storing various types of information for each session relating to display of the web page. It may be determined whether the web browser 201 applies the above-described management using the sessions to the control relating to display of a web page, for example, based on settings of the web browser 201.

In step S215, the web browser 201 outputs the web page to the display device 104. A screen (an area) 300 illustrated in FIG. 3 is displayed on the display device 104 via the processing in step S215.

FIG. 3 is a diagram illustrating an example of the screen 300 of the web page according to the present embodiment. In the example illustrated in FIG. 3, the screen 300 includes a header display portion 310, the inquiry display portion 320, and a content display portion 330. The inquiry display portion 320 is displayed when the inquiry screen display flag in the volatile storage area of the RAM 103 is set to ON. When the inquiry screen display flag is not set to ON, the inquiry display portion 320 is hidden.

The header display portion 310 includes an address bar 311 for displaying the URL corresponding to a web page.

The inquiry display portion 320 includes an accept button 321, a reject button 322, and a temporarily accept button 323.

In the example illustrated in FIG. 3, the screen 300 (in particular, the content display portion 330) corresponds to an example of a first screen, and the inquiry display portion 320 corresponds to an example of a second screen.

The description now returns to FIG. 2.

In step S216, the input I/F 105 of the information processing apparatus 100 receives from the user an operation for the accept button 321, the reject button 322, or the temporarily accept button 323, all of which are displayed on the display device 104.

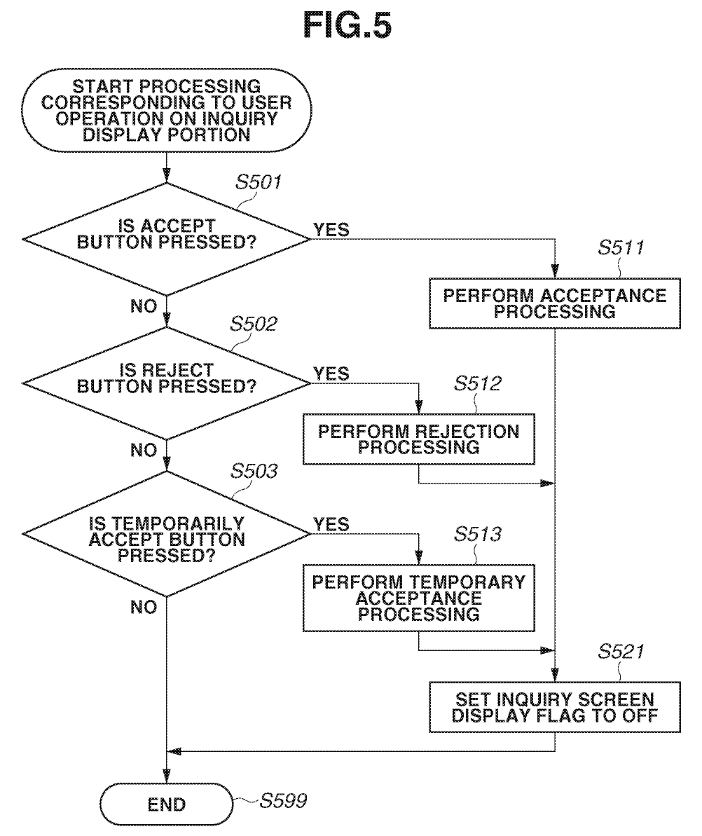

In step S217, the web browser 201 receives the operation by the user to perform processing corresponding to the operation by the user for the inquiry display portion 320 out of the information display control programs included in the web page. Details of the processing in step S217 will be described below with reference to FIG. 5.

In step S218, the web browser 201 reflects on the display device 104 a change in the screen 300 caused by the processing in step S217. The change in the screen 300 caused by the processing in step S217 may be, for example, a change in the inquiry screen display flag in the volatile storage area of the RAM 103. When the inquiry screen display flag is changed from ON to OFF, the web browser 201 outputs to the display device 104 a screen excluding the inquiry display portion 320 from the web page display screen 300 illustrated in FIG. 3.

The processing in step S214 illustrated in FIG. 2 will be described in detail with reference to FIG. 4. Processing of a flowchart illustrated in FIG. 4 starts, for example, in response to the web browser 201 being executed by the CPU 101 of the information processing apparatus 100 receiving from the server 110 a response of the web page described as the processing in step S213 in FIG. 2.

In step S401, the web browser 201 determines whether the information collection accepted flag in the nonvolatile storage area of the ROM 102 is set, and the expiration date of the information collection accepted flag is a time at or after the current time. In this case, a state where the flag is set means a state where the flag is set to ON or OFF (the same applies hereinafter in the present disclosure).

If the web browser 201 determines in step S401 that the information collection accepted flag is set and the expiration date of the information collection accepted flag is a time at or after the current time (YES in step S401), the processing proceeds to step S499. In step S499, the processing of the flowchart ends.

If the web browser 201 determines that at least one of the following conditions is met: the information collection accepted flag is not set or the expiration date of the information collection accepted flag is not a time at or after the current time (NO in step S401), the processing proceeds to step S402.

In step S402, the web browser 201 determines whether the information collection accepted flag in the volatile storage area of the RAM 103 is set.

If the web browser 201 determines that the information collection accepted flag is set (YES in step S402), the processing proceeds to step S499.

If the web browser 201 determines that the information collection accepted flag is not set (NO in step S402), the processing proceeds to step S403.

In step S403, the web browser 201 overwrites the optional information in the nonvolatile storage area of the ROM 102 with a null value. As a result, even when the optional information (individual-related information) collected in the past is stored in the nonvolatile storage area of the ROM 102, the optional information is deleted with execution of the processing in step S403.

In step S404, the web browser 201 sets the inquiry screen display flag in the volatile storage area of the RAM 103 to ON. The processing then proceeds to step S499.

In a case where the web browser 201 applies management using sessions to the control relating to display of a web page, the processing of the flowchart illustrated in FIG. 4 may be individually performed on a per-session basis. In this case, for example, in step S403, the web browser 201 may overwrite the optional information in the nonvolatile storage area allocated to a target session with the null value. As a result, even when the optional information collected in the past is stored in the nonvolatile storage area the target session refers to, the optional information is deleted. In step S404, the web browser 201 may set the inquiry screen display flag managed in the volatile storage area allocated to the target session to ON.

The processing in step S217 illustrated in FIG. 2 will be described in detail with reference to FIG. 5. Processing of a flowchart illustrated in FIG. 5 starts, for example, in response to the web browser 201 being executed by the CPU 101 of the information processing apparatus 100 receiving an operation for the inquiry display portion 320 from the user via the input I/F 105, the operation of which is illustrated as the processing in step S216 in FIG. 2.

In step S501, the web browser 201 determines whether the accept button 321 is pressed by an operation from the user received via the input I/F 105.

If the web browser 201 determines in step S501 that the accept button 321 is pressed (YES in step S501), the processing proceeds to step S511.

If the web browser 201 determines in step S501 that the accept button 321 is not pressed (NO in step S501), the processing proceeds to step S502.

In step S511, the web browser 201 sets the information collection accepted flag in the nonvolatile storage area of the ROM 102 to ON, and sets the expiration date of the information collection accepted flag to a time after a predetermined period elapses from the current time (e.g., 30 days after the current time).

In step S521, the web browser 201 sets the inquiry screen display flag in the volatile storage area of the RAM 103 to OFF.

The processing then proceeds to step S599. In step S599, the processing of the flowchart ends.

After performing the processing in steps S511 and S521, the web browser 201 receives from the user permission to store the optional information in the nonvolatile storage area of the ROM 102, and then hides the inquiry display portion 320.

An example will be described of a state where permission to store the optional information in the nonvolatile storage area of the ROM 102 is received from the user, and the inquiry display portion 320 is hidden with reference to FIG. 7. FIG. 7 is the table 700 illustrating a state of the web browser 201 corresponding to each combination of the flags and the expiration date information.

In the table 700, an information collection accepted flag 711 in the nonvolatile storage area of the ROM 102 and an expiration date 712 of the information collection accepted flag 711 are managed. In the table 700, an information collection accepted flag 713 in the volatile storage area of the RAM 103 and an inquiry screen display flag 714 in the volatile storage area of the RAM 103 are also managed. The table 700 also manages the state of the web browser 201 corresponding to each combination of the above-described information denoted by the reference numerals 711, 712, 713, and 714. Each piece of information denoted by reference numerals 701, 702, 703, and 704 indicates an example of a state of the web browser 201 corresponding to each combination of the above-described information denoted by the reference numerals 711, 712, 713, and 714.

The state 701 of the web browser 201 indicates a state where permission to store the optional information in the nonvolatile storage area of the ROM 102 is received from the user, and the inquiry display portion 320 is hidden. In the state 701, the flag 711 is set to ON, the expiration date 712 of the flag 711 is set to a time at or after the current time, and the flag 713 and the flag 714 are each set to OFF or a null value.

The state 702 of the web browser 201 indicates a state where permission to store the optional information in the nonvolatile storage area of the ROM 102 is not received from the user, and the inquiry display portion 320 is hidden. In the state 702, the flag 711 is set to OFF, the expiration date 712 of the flag 711 is set to a time at or after the current time, and the flag 713 and the flag 714 are each set to OFF or a null value.

The state 703 of the web browser 201 indicates a state where permission to store the optional information in the nonvolatile storage area of the ROM 102 is received from the user, and the inquiry display portion 320 is hidden. In the state 703, the flag 711 and the expiration date 712 of the flag 711 are each set to a null value, the flag 713 is set to ON, and the flag 714 is set to OFF or a null value.

The state 704 of the web browser 201 indicates a state where permission to store the optional information in the nonvolatile storage area of the ROM 102 is received from the user, and the inquiry display portion 320 is hidden. In the state 704, the flag 711 is set to OFF, the expiration date 712 of the flag 711 is set to a time before the current time, the flag 713 is set to ON, and the flag 714 is set to OFF or a null value.

After performing the processing in steps S511 and S521 illustrated in FIG. 5, the web browser 201 is put into the state illustrated as the state 701 in the table 700 illustrated in FIG. 7.

The description now returns to FIG. 5.

In step S502, the web browser 201 determines whether the reject button 322 is pressed by an operation from the user received via the input I/F 105.

If the web browser 201 determines in step S502 that the reject button 322 is pressed (YES in step S502), the processing proceeds to step S512.

If the web browser 201 determines in step S502 that the reject button 322 is not pressed (NO in step S502), the processing proceeds to step S503.

In step S512, the web browser 201 sets the information collection accepted flag in the nonvolatile storage area of the ROM 102 to OFF, and sets the expiration date of the information collection accepted flag to a time after a predetermined period elapses from the current time (e.g., 30 days after the current time).

In step S521, the web browser 201 sets the inquiry screen display flag in the volatile storage area of the RAM 103 to OFF.

The processing then proceeds to step S599.

After performing the processing in steps S512 and S521, the web browser 201 is put into the state illustrated as the state 702 in the table 700 illustrated in FIG. 7.

In step S503, the web browser 201 determines whether the temporarily accept button 323 is pressed by an operation from the user received via the input I/F 105.

If the web browser 201 determines in step S503 that the temporarily accept button 323 is pressed (YES in step S503), the processing proceeds to step S513.

If the web browser 201 determines in step S503 that the temporarily accept button 323 is not pressed (NO in step S503), the processing proceeds to step S599.

In step S513, the web browser 201 sets the information collection accepted flag in the nonvolatile storage area of the ROM 102 to ON.

In step S521, the web browser 201 sets the inquiry screen display flag in the volatile storage area of the RAM 103 to OFF.

The processing then proceeds to step S599.

It is assumed that the web browser 201 performs the processing in steps S513 and S521, and determines in the processing in step S401 illustrated in FIG. 4 that the information collection accepted flag 711 in the nonvolatile storage area of the ROM 102 is not set. In this case, the web browser 201 is put into the state illustrated as the state 703 in the table 700 illustrated in FIG. 7. It is also assumed that the web browser 201 performs the processing in steps S513 and S521, and determines in the processing in step S401 illustrated in FIG. 4 that the expiration date of the information collection accepted flag 711 in the nonvolatile storage area of the ROM 102 is a time before the current time. In this case, the web browser 201 is put into the state illustrated as the state 703 in the table 700 illustrated in FIG. 7.

When the web browser 201 is in the state 701, 703, or 704 illustrated in FIG. 7, the user accepts storage of the optional information in the nonvolatile storage area of the ROM 102. Thus, with permission to use the optional information received by the user, the web browser 201 can store the optional information in the nonvolatile storage area of the ROM 102, and then display information suitable for the user on the content display portion 330 using the optional information.

Similar to the example illustrated in FIG. 4, in a case where the web browser 201 applies management using sessions to the control relating to display of a web page, the processing of the flowchart illustrated in FIG. 5 may be individually performed on a per-session basis. In this case, the web browser 201 may individually manage the information collection accepted flag and the expiration date of the information collection accepted flag for each session using the nonvolatile storage area allocated to a target session.

As described above, the information processing system according to the present embodiment enables the user to express consent to collection of individual-related information, where the consent is limited to while the web browser 201 is running (e.g., limited to the same session associated with display of the web page).

In other words, in a case where a second session different from a first session is started, a predetermined operation is received again for the user’s expressing consent to the collection of individual-related information. As a specific example, in a case where a session is assigned to each window or each tab for display of a web page, the user can express consent to the collection of individual-related information, where the consent is limited to a web page being displayed in each tab or each window. This enables the user to easily change their expression of consent to or rejection of the collection of individual-related information, which makes it possible to reduce cases where the user avoids consent to the collection of individual-related information because the individual-related information continues to be stored.

### Second Embodiment

A second embodiment of the present disclosure will now be described. In the above-described first embodiment, an example is described where the web browser 201 displays both the accept button 321 and the temporarily accept button 323 on the display device 104. In the second embodiment, in a case where the user enters into the web browser 201 a URL corresponding to a web page that includes an information display control program with a predetermined query parameter added to the URL, an operation relating to display of an accept button 321 and a temporarily accept button 323 is controlled. Specifically, when the predetermined query parameter is added to the input URL, the web browser 201 displays, on a display device 104, the temporarily accept button 323 but not the accept button 321.

An example will be described of processing by an information processing system according to the present embodiment with reference to FIG. 2.

The processing in steps S211 to S214 is the same as that in the above-described first embodiment. Thus, detailed description of the processing will be omitted.

In step S215, the web browser 201 outputs the web page to the display device 104. Aa screen 300 illustrated in FIG. 3, as described above, is displayed on the display device 104 via the processing in step S215.

According to the present embodiment, if the predetermined query parameter is added to the URL in the processing in step S211, the reject button 322 and the temporarily accept button 323 are displayed in the inquiry display portion 320, and the accept button 321 is hidden If a predetermined query parameter is not added to the URL in the processing in step S211, the accept button 321 and a reject button 322 are displayed in the inquiry display portion 320, and the temporarily button 323 is hidden.

As described above, in step S216, an input I/F 105 of an information processing apparatus 100 receives from the user an operation for the accept button 321, the reject button 322, or the temporarily accept button 323, all of which are displayed on the display device 104. In the present embodiment, if the predetermined query parameter is added to the URL in the processing in step S211, the accept button 321 is hidden on the display device 104, and is not available to be pressed by the user. If the predetermined query parameter is not added to the URL during the processing in step S211, the temporarily accept button 323 is hidden on the display device 104, and will not be available to be pressed by the user.

The processing in steps S217 and S218 is the same as that in the above-described first embodiment. Thus, detailed description of the processing will be omitted.

The above-described predetermined query parameter according to the present embodiment corresponds to an example of first additional information.

As described above, the information processing system according to the present embodiment can achieve similar effects to those described in the first embodiment. In addition, in the information processing system according to the present embodiment, the reception of consent to the collection of individual-related information, where the consent is limited to while the web browser 201 is running is selectively switched based on whether the URL includes a designated query parameter. In other words, when browsing the web page through a predetermined operation, such as reading of a QR code^{®} that includes the URL corresponding to the web page and the predetermined query parameter, the user can express consent to the collection of individual-related information, where the consent is limited to while the web browser 201 is running. This enables the user to easily change their expression of consent to or rejection of the collection of individual-related information, which makes it possible to reduce cases where the user avoids consent to the collection of individual-related information because the individual-related information continues to be stored.

### Third Embodiment

A third embodiment of the present disclosure will now be described. In the above-described first embodiment and second embodiment, the web browser 201 causes the display device 104 to display the inquiry display portion 320, and the user’s temporary consent to the collection of individual-related information by the temporarily accept button 323 being pressed. In the present embodiment, when the URL corresponding to a web page that includes an information display control program is entered into a web browser 201, and a predetermined query parameter is added to the URL, the web browser 201 hides the inquiry display portion 320. The web browser 201 considers the user to have limited the consent to the collection of individual-related information to while the web browser 201 is running.

An example of processing by an information processing system according to the present embodiment will be described with reference to FIG. 2.

The processing in steps S211 to S213 is the same as that in the above-described first embodiment. Thus, detailed description of the processing will be omitted.

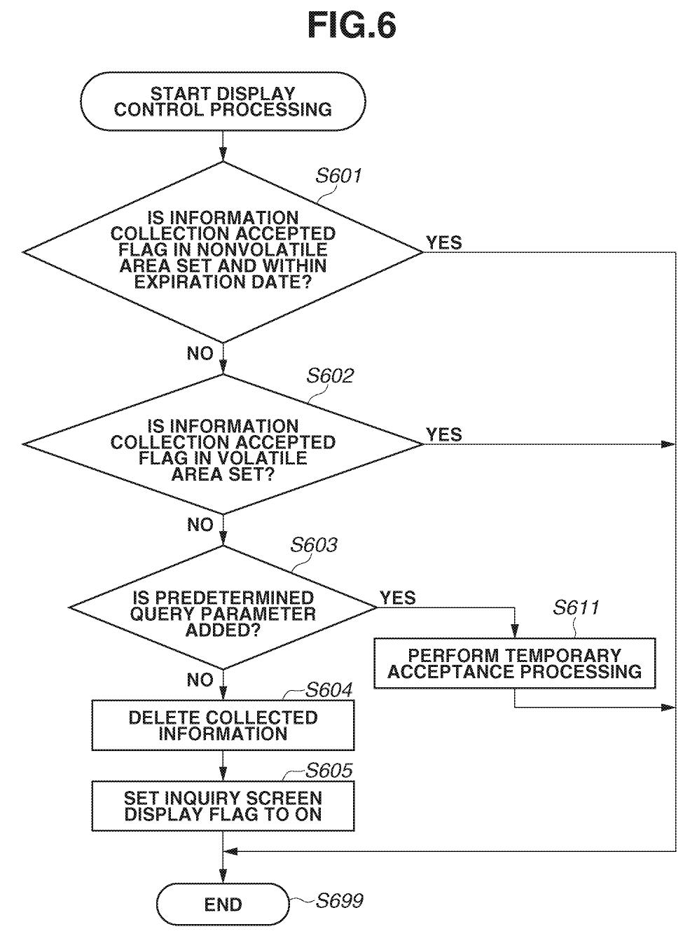

When the web browser 201 receives a response from a server 110 in step S213, the web browser 201 performs display control processing of the information display control program included in the web page in step S214. Details of the processing in step S214 according to the present embodiment will be separately described below with reference to FIG. 6.

Processing of a flowchart illustrated in FIG. 6 starts, for example, in response to the web browser 201 being executed by a CPU 101 of an information processing apparatus 100 receiving a response of the web page described as the processing in step S213 in FIG. 2 from the server 110.

In step S601, the web browser 201 determines whether an information collection accepted flag in a nonvolatile storage area of a ROM 102 is set, and the expiration date of the information collection accepted flag is a time at or after the current time.

If the web browser 201 determines that the information collection accepted flag is set and the expiration date of the information collection accepted flag is a time at or after the current time (YES in step S601), the processing proceeds to step S699. In step S699, the processing of the flowchart ends.

If the web browser 201 determines that at least one of the following conditions is met: the information collection accepted flag is not set or the expiration date of the information collection accepted flag is not a time at or after the current time (NO in step S601), the processing proceeds to step S602.

In step S602, the web browser 201 determines whether the information collection accepted flag in a volatile storage area of a RAM 103 is set.

If the web browser 201 determines that the information collection accepted flag is set (YES in step S602), the processing proceeds to step S699.

If the web browser 201 determines in step S602 that the information collection accepted flag is not set (NO in step S602), the processing proceeds to step S603.

In step S603, the web browser 201 determines whether a predetermined query parameter is added to the URL entered in the processing in step S211 illustrated in FIG. 2.

If the web browser 201 that a predetermined query parameter is added to the URL (YES in step S603), the processing proceeds to step S611.

If the web browser 201 determines that the predetermined query parameter is not added to the URL (NO in step S603), the processing proceeds to step S604.

The above-described query parameter according to the present embodiment corresponds to an example of second additional information.

In step S611, the web browser 201 sets the information collection accepted flag 713 in the volatile storage area of the RAM 103 to ON. The processing then proceeds to step S699.

If the web browser 201 performs the processing in step S611 and then determines in step S601 that the information collection accepted flag in the nonvolatile storage area of the ROM 102 is not set, the web browser 201 enters the state illustrated as the state 703 in the table 700 illustrated in FIG. 7. If the web browser 201 performs the processing in step S611 and then determines in step S601 that the expiration date of the information collection accepted flag in the nonvolatile storage area of the ROM 102 is a time before the current time, the web browser 201 enters the state illustrated as the state 704 in the table 700 illustrated in FIG. 7.

In step S604, the web browser 201 overwrites optional information in the nonvolatile storage area of the ROM 102 with a null value. As a result, even when the optional information (the individual-related information) collected in the past is stored in the nonvolatile storage area of the ROM 102, the optional information is deleted with execution of the processing in step S604.

In step S605, the web browser 201 sets an inquiry screen display flag 714 in the volatile storage area of the RAM 103 to ON.

The processing then proceeds to step S699.

Returning to FIG. 2, the processing in steps S215 to S218 is the same as that in above-described first embodiment. Thus, detailed description of the processing will be omitted.

Similar to the example described with reference to FIG. 4, in a case where the web browser 201 applies management using sessions to the control relating to display of a web page, the processing of the flowchart illustrated in FIG. 6 may be individually performed on a per-session basis.

As described above, the information processing system according to the present embodiment can achieve similar effects to those described in the first embodiment and the second embodiment. In addition, in the present embodiment, at the time of browsing a web page, with a predetermined query parameter included in the URL, the user can limit expressing consent to the collection of individual-related information without operating a button 323 to while the web browser 201 is running. In other words, in the present embodiment, the user’s expression of consent to the collection of individual-related information is received via an operation, such as designation of a query parameter to a URL, and reading of the URL including the query parameter (e.g., reading of QR code^{®}), in place of operating the button 323.

According to the above-described embodiments, a user’s expression of consent to collection of individual-related information can be received in a more suitable form while the user is browsing a web page.

### Other Embodiment

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-004918, filed January 14, 2025, which is hereby incorporated by reference herein in its entirety.

What is claimed is:

1. A method comprising:
receiving a predetermined operation performed to obtain consent to collection of individual-related information about a user, where the consent is limited to a first session relating to management of display of a screen; and
deleting the individual-related information in a case where the predetermined operation is received.

2. The method according to claim 1, wherein in a case where a second session different from the first session is started, the predetermined operation is received again.

3. The method according to claim 1, further comprising setting, in a case where the predetermined operation is received, a flag indicating consent to the collection of the individual-related information in a volatile storage area,
wherein, in a case where the first session is started and the flag is set, the individual-related information is deleted.

4. The method according to claim 1, further comprising displaying a predetermined region included in the screen and used to obtain consent to the collection of the individual-related information about the user, where the consent is limited to the first session,
wherein the predetermined operation is performed on the predetermined region included in the screen and used to obtain the consent to the collection of the individual-related information about the user, where the consent is limited to the first session.

5. The method according to claim 4,
wherein, in a case where additional information is added to information used to display the screen, the predetermined region is controlled to be displayed, and
wherein, in a case where the additional information is not added to the information used to display the screen, the predetermined region is controlled not to be displayed.

6. The method according to claim 1, wherein the predetermined operation is performed to designate additional information for information used to display the screen, wherein the predetermined operation is operation relating to reading of an encoded code of information obtained by adding the additional information to the information used to display the screen.

7. An information processing apparatus comprising:
at least one memory storing a program; and
at least one processor, that when executing the program, is causes the information processing apparatus to:
receive a predetermined operation performed to obtain consent to collection of individual-related information about a user, where the consent is limited to a specific session relating to management of display of a screen; and
delete the individual-related information in a case where the predetermined operation is received.

8. A non-transitory computer-readable storage medium storing a program for causing a computer execute a method, the method comprising:
receiving a predetermined operation performed to obtain consent to collection of individual-related information about a user, where the consent is limited to a specific session relating to management of display of a screen; and
deleting the individual-related information in a case where the predetermined operation is received.
